(19) United States
(12) Patent Application Publication
(10) Pub. No.: US 2006/0038885 A1
(43) Pub. Date: Feb. 23, 2006

(54) Method for detecting the environment ahead of a road vehicle by means of an environment detection system

(76) Inventors: Helmuth Eggers, Ulm (DE); Gerhard Kurz, Wendlingen (DE); Juergen Seekircher, Ostfildern (DE); Thomas Wohlgemuth, Aichtal (DE)

Correspondence Address: PENDORF & CUTLIFF, 5111 MEMORIAL HIGHWAY, TAMPA, FL, 33634-7356, US

(21) Appl. No.: 10/535,157

(22) PCT Filed: Nov. 11, 2003
(86) PCT No.: PCT/EP03/12572

§ 371 Date: May 16, 2005

(30) Foreign Application Priority Data
Nov. 28, 2002 (DE) 102 55 797.7

(51) Int. Cl. H04N 7/18

(52) U.S. Cl. 348/135; 250/342

(57) ABSTRACT

Environment detection systems are used to aid drivers in road vehicles. To this end, optical sensors are applied to the road vehicle in order to record environmental data. The recorded environmental data is processed to form an image by means of a computing unit, and is then presented to the driver, for example on a display. In addition, the image data can be subjected to a further evaluation, for example, in order to identify objects located therein. For this purpose, a very large amount of data must be processed however, such that the requirements for the efficiency of the hardware are very high, in order to provide the system with a real-time capacity. The invention thus relates to a method which provides the system with a real-time capacity by means of simple data processing. By carrying out a multi-stage evaluation in individual identification partial regions and by limiting the identification region to the region of the driving lane, the quantity of data to be evaluated can be considerably reduced and the data can be rapidly processed during the environment detection process.

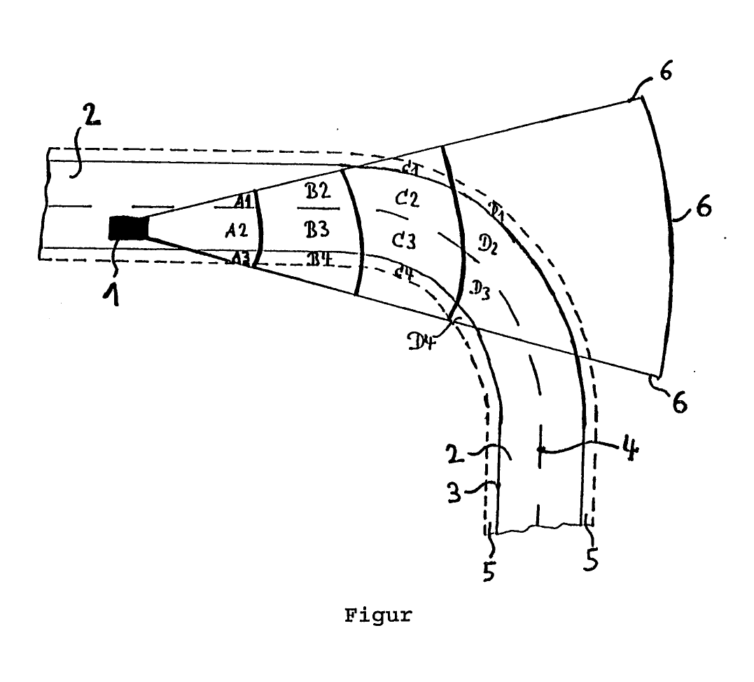

### BACKGROUND OF THE INVENTION

1. Field of the Invention

The invention relates to a method for sensing the surroundings in front of a road vehicle by means of a surroundings sensing system.

2. Related Art of the Invention

Driver assistance systems are used to support the driver in vehicles. Inter alia, surroundings-sensing systems are used in this context. Such systems serve to warn the driver about obstacles and other sources of danger and thus avoid traffic accidents. Obstacles are detected here mainly by means of optical sensors. For this purpose, CCD sensors and infrared sensors are mounted on the road vehicle in order to record surroundings data both in the day and during night driving. The surroundings data which is recorded is processed to form an image by means of a computer unit connected to the sensor system, and said data is then presented to the driver, for example on a display. However it is also conceivable to subject the image data to an evaluation in order, for example, to perceive objects in it.

The U.S. patent with the U.S. Pat. No. 6,201,236 B1 describes an opto-electronic system for detecting objects within a restricted monitoring region. For this purpose, the system comprises a plurality of LED transmitters and photo receivers which are mounted in pairs on a road vehicle. The LED transmitters are operated in a pulsed fashion and in the process illuminate the monitoring region. Objects which are located in the monitoring region are then detected by means of the photo elements, as a result of the light reflected at the objects. The LED transmitters and receivers are operated with a control unit, with the detected signal being evaluated in such a way that it is possible to distinguish between the light which is reflected by objects and the surroundings light. The evaluation which is carried out by means of the control unit is selective in order to be able to adapt the limits of the monitoring region to the conditions in the surroundings. For example, the monitoring region shrinks if narrow roads containing a lot of bends are passed through. The size of the monitoring region also depends on the type of vehicle (lorry, passenger car, etc.) since the dead angle and thus the region to be monitored changes with the type of vehicle. The size of monitoring region is defined in such a way that the system can perceive other vehicles which are located in the dead angle of the vehicle and move in an adjacent lane. The monitoring region is also limited so that adjacent lanes can be detected but no objects such as, for example, road signs, fences, walls etc.

The UK patent application with the publishing number GB 2352859 A describes a monitoring system which serves to monitor a 3-D space and comprises at least two cameras. One or more volumes which are to be monitored are defined within a 3-D space, said volumes being, for example, dangerous spaces or shut-off areas. Since two or more cameras are used, the system can sense whether an object penetrates the volume to be monitored. The volume to be monitored is defined by the user by means of a drawing. The drawing contains here the contours about an object in at least two views. The views being selected in such a way that they correspond to the camera arrangement and by means of the camera arrangement it is possible to sense one object simultaneously by both cameras. If the cameras are arranged in a coplanar fashion for two objects moving in the field of vision, a total of four delimited monitoring regions are described with the intersecting optical beams of the cameras. The monitoring regions change here in their size as the objects move.

A system for supporting the driver's vision at night is presented on the Internet page of the Toyota Motor Corporation (www.toyota.co.jp/Showroom/All toyota lineup/LandCruiserCygnus/safety/index.html). Here, the surroundings are sensed by means of a camera which is sensitive in the near-infrared range, and the surroundings are displayed to the driver on a head-up display. When the headlights are dipped the system shows the course of the road which lies in front of the light beam of the vehicle and is difficult to discern, as well as persons, vehicles and obstacles located in the surroundings. For this purpose, a region which can be perceived with the night vision system adjoins the light beam of the dipped headlights. The region which can be perceived is ideally at approximately 100 m and extends at maximum to approximately 150 m.

The system also serves as an assistant for remote vision, in particular in situations in which it is not possible to travel with high beam. When the vehicle is travelling with high beam, the system provides the driver with advance information by imaging objects which are difficult to perceive in direct vision. By using near-infrared beams the system can indicate the state of the road, objects which have fallen onto the road and other information about the road. For this purpose, the region which can be imaged with the night vision system is adjacent to the light beam of the high beam, which is stipulated as having a range of approximately 180 m. The region which can be imaged is stipulated as being ideally 200 m and at maximum approximately 250 m.

When such a system is operating, such a large amount of data to be evaluated is very disadvantageous under real conditions. Correspondingly, the requirements made of the efficiency of the hardware in order to achieve a real-time capability are very high. For this reason, until now very complex and also very expensive special hardware has been used in systems for sensing the surroundings.

### SUMMARY OF THE INVENTION

The invention is therefore based on the object of providing a method with which the surroundings in front of a road vehicle can be sensed using a surroundings sensing system and objects which are located in front of said vehicle can be detected, with a real-time capability of the system being implemented by a simple data processing means.

The object is achieved according to the invention by means of a method having the features of patent claim 1. Advantageous refinements and developments of the invention are disclosed in the subclaims.

According to the invention, a method is used for sensing the surroundings in front of a road vehicle using a surroundings sensing system. In which case the surroundings sensing system may be, in particular, an infrared night vision system. In order to sense surroundings data the system comprises at least one surroundings sensor. Said sensor may be, for example, a stereo camera system, a radar sensor in conjunction with a camera, a combination of an infrared laser and a camera or an ultrasonic sensor in combination with a camera. Objects within the surroundings data sensed by the surroundings sensor are detected by processing the sensor data. In which case the region in which the objects are perceived is configured in such a way that it corresponds to a component-region of the region which is sensed by the camera. The perception region is divided according to the invention into a plurality of component-regions. Owing to the division into such perception component-regions it is then possible to subject surroundings data to a specific evaluation. For example, the evaluation is carried out with a higher priority in a near region than in a more distant region. It is also conceivable to make different computing capabilities, for example complex, multi-stage algorithms, available for different perception regions.

Before the perception region is divided into a plurality of component-regions in the perception region, a lane detection is also carried out according to the invention. In order to determine the course of the lane it has proven valuable to use image processing methods. However, it is also conceivable to determine the lane on the basis of information of a navigation system. The lane can be included directly in the images of the sensing of the surroundings and displayed to the driver.

The invention makes it possible to carry out real-time-capable forward-looking sensing of the surroundings using standard hardware. By means of a specific evaluation within individual perception component-regions on the one hand and restriction of the perception region to the region of the lane, on the other hand, the quantity of data to be evaluated is considerably reduced, thus permitting rapid processing of the data for the sensing of the surroundings.

In one beneficial embodiment of the invention, the perception region is restricted in such a way that, for the purpose of delimiting the lane, a further predefined tolerance region is also added. It is thus possible not only to restrict the perception to the lane but also to carry out an evaluation in the tolerance regions next to the lane for the individual perception component-regions. As a result, objects which are located at the edge of the road, such as road signs, persons etc. can be sensed within perception component-regions and thus evaluated specifically with respect to the individual component-regions. The tolerance region can be included in the images of the sensing of the surroundings.

The perception of the object can be carried out by the image processing system, in such a way that, for example, said image processing system displays the surroundings data on a display for evaluation by a person. Alternatively, it is suitable to carry out computer-supported perception for automatic evaluation. Methods which are based on sensor data processing methods are particularly suitable for automatic object perception. If the surroundings sensor senses, for example, a camera, image processing methods for processing the surroundings data are advantageously suitable. A large number of methods are already known for this purpose from the prior art, for example template matching, edge-based or contour-based methods. The method according to the invention is particularly advantageous in conjunction with image processing methods since the object sizes which occur in the different perception component-regions can be estimated satisfactorily in advance. Imaging processing algorithms can thus be adapted in an optimum way for each individual perception component-region. For example, when a template matching method is used it is possible to work within a perception component-region with a small number of templates, with approximately the same object sizes and types of objects being presented. Using a small number of templates permits the method to be processed with corresponding speed.

It is also conceivable to carry out object classification for the purpose of carrying out evaluation in the perception region. In which case the object classification can be used alone or additionally in combination with other methods, predominantly in order to minimize false alarms. In particular in the case of the classification methods which are based on learning from examples it is possible to adapt different classifiers for different perception component-regions. Different learning samples are generated for different perception component-regions, in order to adapt the classifiers. In this context, a learning sample for a perception component-region comprises only such patterns whose type of object can also actually appear within the perception component-region. For example, traffic signs do not appear within the lane but rather at the edge of the lane. The scaling for a pattern of a learning sample within a perception component-region can also be satisfactorily predicted so that the number of patterns may be small.

For example, on the basis of a classification it is possible to check an object there detected by means of image processing to determine whether the object is actually an obstacle or another object which can usually appear within a traffic scene and does not constitute a danger, for example oncoming traffic.

In a further advantageous refinement of the invention, the distance from the objects which are perceived by means of image processing methods or classification methods is determined. The driver can thus be warned in good time of dangers or obstacles, for example. In which case the distance from objects can be measured by means of a distance measuring sensor, for example with a laser sensor or radar sensor. However, the distance from objects can also be determined by reference to the image data of the sensing of the surroundings. It is also conceivable to determine the distance by reference to the relationship between a perceived object and a perception component-region.

For the detection of objects it is possible to use a combination of distance measuring and speed measuring methods as well as classifying methods. By using tracking methods it is possible to carry out an evaluation in the perception region in such a way that both the direction of movement and the speed of movement of objects can be sensed. In particular, methods with which differences in the lateral movement can be satisfactorily perceived are used. For example, obstacles which suddenly appear or vehicles which move out are indicated to the driver.

The method according to the invention can be particularly advantageously used in conjunction with a safety system in a road vehicle for acting on other vehicle-internal systems. For example, control signals can be transmitted to the control unit of an ACC application in order to avoid collisions. Signals can also be transmitted to safety devices, for example in order to pre-activate the airbag.

An exemplary embodiment of the invention will be explained in detail below with reference to a FIGURE.

### DETAILED DESCRIPTION OF THE INVENTION

The FIGURE shows by way of example a traffic scene using the method according to the invention in order to sense the surroundings in front of a road vehicle (1) by means of a surroundings sensing system. In which case the road vehicle is located on a road with a plurality of lanes (2). The boundaries (6) of the region imaged by the surroundings sensing camera extend beyond the lane boundaries (3). The perception region of the system is intended to include here only a component-region of the region which can be imaged by the camera. The perception region is also intended to be divided into a plurality of component-regions (A . . . D) in order to subject the surroundings data to a multi-stage evaluation. The perception region is restricted in this example to the region which is located within the lane boundaries (3). Also, a further tolerance region (5) is added in addition to the preception region in order, for example, to perceive road signs in this region. If the central markings (4) are also included, up to four perception component-regions (C1 . . . C4) are produced one next to the other, for example, when there are two lanes (2) as indicated in the figure. Correspondingly it is conceivable for the number of perception component-regions which are located one next to the other to increase with the number of lanes (2).

### LIST OF REFERENCE SYMBOLS

1 Road vehicle with a surroundings sensor system
2 Lane
3 Lane boundary
4 Central markings
5 Tolerance region
6 Boundary of the imaging region of the camera
A1 . . . D4 Perception component-regions

1. A method for sensing the surroundings in front of a road vehicle by means of a surroundings sensing system, system in which the surroundings data is sensed by means of a surroundings sensor, and objects within the surroundings data sensed by the surroundings sensor are detected by processing the sensor data,
wherein the perception region in which the objects are detected corresponds to a component-region of the region sensed by the surroundings sensor,
wherein the perception region is divided into a plurality of component-regions, and evaluation takes place in one component-region and no evaluation takes place in another component-region,
wherein the surroundings data is subjected to a multi-stage evaluation,
wherein before the perception region is divided into a plurality of component-regions in the perception region a lane is firstly defined in order to subsequently restrict the perception region to the lane, and
wherein each of these component-regions is subjected to a specific evaluation.

2. The method as claimed in claim 1, wherein the lane is defined in that either a lane detection is carried out by image processing methods or a lane is defined by means of the data of a navigation system.

3. The method as claimed in claim 1, wherein the perception region is restricted in such a way that, for the purpose of delimiting the lane, a further predefined tolerance region is also added.

4. The method as claimed in claim 1, wherein, for the purpose of carrying out evaluation in the perception region, object perception is carried out by means of image processing methods.

5. The method as claimed in claim 1, wherein, for the purpose of carrying out evaluation in the perception region, object classification is carried out by means of classification methods in order to rule out false alarms.

6. The method as claimed in claim 4, wherein, for the purpose of evaluation in the perception region, the distance from detected objects is determined in order to be able to provide information about obstacles in good time.

7. The method as claimed in claim 1, wherein, for the purpose of carrying out evaluation in the perception region by means of tracking methods, the movement of objects is sensed in order to perceive whether their direction of movement corresponds to the vehicle's own movement.

8. (canceled)

9. The method as claimed in claim 1, wherein the surroundings sensing system, is an infrared night vision system.
